(19) United States
(12) Patent Application Publication
(10) Pub. No.: US 2003/0041047 A1
(43) Pub. Date: Feb. 27, 2003

(54) Concept-based system for representing and processing multimedia objects with arbitrary constraints

(75) Inventors: Yuan-Chi Chang, Ossining, NY (US); Chung-Sheng Li, Ossining, NY (US); Apostol Ivanov Natsev, Durham, NC (US); John R. Smith, New Hyde Park, NY (US)

Correspondence Address: F. CHAU & ASSOCIATES, LLP, Suite 501, 1900 Hempstead Tpke., East Meadow, New York, NY, 11554, US

(73) Assignee: International Business Machines Corporation, Armonk, NY (US)

(21) Appl. No.: 09/925,397

(22) Filed: Aug. 9, 2001

(51) Int. Cl. G06F 7/00

(52) U.S. Cl. 707/1

(57) ABSTRACT

Disclosed is a method and apparatus for querying stored multimedia data in a computer system, comprising receiving into an intermediate level a high-level concept from a user describing data to be retrieved, translating, in said intermediate level, said high-level concept into low-level queries by using system pre-defined high-level concepts, transferring said low-level queries to a low level comprising one or more search engines; said one or more search engines performing a query of the stored multimedia information using said low-level queries. A matching algorithm for use with the invention is also disclosed.

### FIELD OF THE INVENTION

The present invention is directed to the problem of high-level semantic querying of multimedia data from various application domains. In particular, the invention describes a concept-based querying framework with a novel and powerful concept representation model. In association with the novel representation model, efficient concept-matching algorithms are proposed to hierarchically define and label new concepts through joining multiple rank-ordered fuzzy result sets with user-defined join conditions. Each of the rank-ordered sets represents an instantiation of a more basic concept and each join condition represents a relation characterizing two or more basic concepts.

### BACKGROUND OF THE INVENTION

The problem of searching multimedia data has received considerable attention in the last few years. The early image query systems, such as IBM's QBIC, MIT's Photobook, the Virage system, and the like, were invented in the early to mid 90s. Those systems typically took an image or a sketch as input, computed some visual features from it (e.g., color histograms, texture, shape features), and searched one or more indexes to return images with similar features. Alternatively, one could specify values for these features and appropriate weights reflecting their relative importance. Being the first to use content-based search, those systems were a big improvement over the method of manually annotating images and doing a text search to find relevant ones.

Researchers then focused on studying other types of features, such as wavelets, or localizing the features to sub-image regions. By segmenting the images into their regions, or objects, and comparing images at the object level, such systems got closer to the mental model of the user of how image similarity is established. They were also able to exploit not only visual feature similarity but also the relationships among the image objects, such as their spatial arrangements, for example. However, the types of relationships, or constraints, were limited by the indexing methods used. The approach used in these systems was that the system should compute the relevant constraints among the objects transparently to the user, and therefore the user had little control over the types of relationships used.

The use of intermediate levels between the user and a database's search engines are known in the CAMEL image query system, such as is disclosed in A. Natsev et al., CAMEL: CONCEPT ANNOTATED IMAGE LIBRARIES, Storage and Retrieval for Image and Video Databases, San Jose, Calif., SPIE, (January 2001) and the multimedia thesaurus system MediaNet, as disclosed in A. B. Benitez et al., MEDIANET: A MULTIMEDIA INFORMATION NETWORK FOR KNOWLEDGE REPRESENTATION, Conference on Internet Multimedia Management Systems, volume 4210, Boston, Mass., IST/SPIE 2000 (November 2000).

Knowledge Representation

One of the components of a concept-based query system is how concepts are represented. If too simple, the whole framework would be too limited and useless for many applications. On the other hand, an overly complex representation would not be supported natively by many search systems, which will make the entire query process very inefficient. In search of the right balance, we hereby consider some previous knowledge representation schemes.

Attributed Relational Graphs (or ARGs) are one form of representation used previously to capture inter-object constraints by E. Petrakis and C. Faloutsos, SIMILARITY SEARCHING IN MEDICAL IMAGE DATABASES, IEEE Transactions on Knowledge and Data Engineering, 9(3):435-447 (May/June 1997). The nodes in ARGs correspond to objects, while the edges represent their relationships. ARGs are very similar to semantic networks, which were used in Artificial Intelligence and computer vision. Both of these representations are very good candidates for our purposes, however, they lack an appropriate hierarchical structure necessary for support of nested fuzzy views, and they do not have a suitable mechanism for specifying representation parameters that can be used for learning or extraction purposes, or to tune a representation to a particular data set, for example.

Knowledge representations that include such parameters in the form of weights or conditional probabilities include neural networks and belief networks (or Bayesian networks). Both of them have nodes representing particular states, and weights or probabilities corresponding to the transition between these states. Neural networks were not entirely suitable for our purposes because their intermediate states do not correspond to any intuitive concepts but are there simply for auxiliary purposes. In Bayesian networks, on the other hand, all states are well-defined and have a clear interpretation or meaning that can be translated into a concept. However, the parameters on the state transitions actually correspond to conditional probabilities, while for our purposes, we only need weights to express relative importance of the inner nodes or concepts. We have therefore used a mixture of the above representations that uses a hierarchical fuzzy graph data structure.

Fuzzy Join Methods

Every database query system or a search engine supports filtering by constraints to a certain extent. Typically, the support extends to scalar predicates that can be evaluated for each database records independently of other records, as well as some form of aggregate predicates, where the value of the predicate for a given item depends on the other items in the database as well (e.g., nearest neighbor or top-k queries). Indexing support is usually limited for such queries and the execution becomes even more inefficient when several constraints are combined.

Spatial and attributional constraints, for example, have been integrated previously by Petrakis and Faloutsos, Id., where the authors proposed a method for searching medical images according to their attributed relational graphs (ARGs). The method relies on the assumption that certain objects are contained in all images from a given domain (e.g., heart, lungs, etc.) in addition to a variable number of objects that are unexpected (e.g., tumor). The specific structural relationships among such objects are stored in ARGs and are used for computing image similarity. The above assumption does not generalize or scale well, however, and the indexing method is fairly ineffective if the number of unlabeled objects is large (which is typically the case for most domains). Other methods for encoding spatial relationships are the 2-D strings, which capture the relative position of objects with respect to the other objects in the set. Smith and Chang disclose a query processing system for spatial and feature-based image queries, J. R. Smith and S. F. Chang, INTEGRATED SPATIAL AND FEATURE IMAGE QUERY, Multimedia Systems, 7(2): 129-140, (1999), wherein the retrieval is based on specifying absolute or relative position constraints on the objects in the image. However, the proposed pipeline and parallel processing methods do not guarantee the lack of false dismissals.

The problem of supporting Boolean combinations on multiple ranked independent streams was considered first by Fagin for the case of top-k queries, R. Fagin, FUZZY QUERIES IN MULTIMEDIA DATABASE SYSTEMS, Proc. of the 1998 ACM SIGACT-SIGMOD-SIGART Symposium on Principles of Database Systems, (1998); R. Fagin, COMBINING FUZZY INFORMATION FROM MULTIPLE SYSTEMS, Journal of Computer and System Sciences, 58:83-99 (1999) [an extended abstract of this paper appears in Proc. Fifteenth ACM Symp. on Principles of Database Systems (PODS '96), Montreal, 1996, pp. 216-226].

M. Ortega, et al., INFORMATION RETRIEVAL OVER MULTIMEDIA DOCUMENTS, Technical Report TR-MARS-99-11, University of California, Irvine, Calif. (1999) and M. Ortega, et al., SUPPORTING RANKED BOOLEAN SIMILARITY QUERIES IN MARS, IEEE Trans. on Knowledge and Data Engineering, 10 (November-December 1998) disclose a similar problem of combining multiple similarity scores for the same document in a weighted fashion so that the overall score is a combination of how well the document matched the query with respect to both text and image parts. In their MARS database system, they defined a query tree whose nodes represented intermediate matches derived from the matches at the children nodes, and evaluated it from the bottom up, arriving at the final similarity score at the root. Both approaches, however, considered only Boolean conjunctions and disjunctions as the join constraints, and only a single level of a join hierarchy. The MARS approach did use a multi-level query tree but the different levels were derived simply by breaking up a single join level of multiple streams into a hierarchy of pairwise joins. Neither approach therefore considered nested fuzzy views or fuzzy joins with arbitrary constraints.

The SPROC algorithm disclosed by C. S. Li et al., SEQUENTIAL PROCESSING FOR CONTENT-BASED RETRIEVAL OF COMPOSITE OBJECTS, Storage and Retrieval of Image and Video Databases, VI, SPIE (1998) addresses the problem of joining fuzzy result sets by means of specifying arbitrary fuzzy constraints among them (see FIG. 6 for example). It allows the user to express the query as a set of sub-queries (nodes in a graph), along with fuzzy constraints among them (edges between the nodes). The problem is solved by looking for a maximal cost path, computed with a Vitterbi-like algorithm. Based on certain assumptions, the algorithm allowed both pruning of some edges, as well as some nodes. The assumptions were that no nodes participate in more than one constraint and that there were no cycles. This method is the most general of the above-described methods but is still designed for a single hierarchy level.

The advances in computing power over the last few years have made a considerable amount of multimedia data available on the web and in domain-specific applications. The result has been an increasing emphasis on the requirements for searching and describing such large repositories of multimedia data. One of the first realizations about this new field was the fact that the traditional database model for querying of structured data does not generalize well to multimedia domains of unstructured data. One reason was that in databases, the results were always well-defined and unordered sets (i.e., each item was either in or out of the result set), while in multimedia queries, the results were fuzzy and typically ordered by their degree of similarity to the query. Another difference was in the way the data was queried. While the relational database model treated all items as feature sets and consequently all queries were on the features, it was not apparent how to convert a sample image query into an feature query in a meaningful and simple fashion. This led to the widespread adoption of the query by example (or query by content) model for image search, where the user would specify a sample image and the system would return images that are similar in color, shape, texture features, and the like.

The above query model has some advantages, such as comparison and ranking of images based on objective visual features, rather than on subjective image annotations, for example; and automated indexing of the image data, as opposed to labor consuming manual image annotation. However, this model has its drawbacks as well. For one, in some applications it is difficult to find an appropriate query sample from the same domain, or it may be difficult to provide it to the query engine. In most cases, he/she would have to do an extra text search step in the image annotations (file name, URL, surrounding text context, etc.), in order to find suitable image candidates to start the content-based search. However, even then, they may not find a suitable query image, and this reduction of the image search problem to a text search one is only a workaround rather than a permanent fix for the problem. In other domains, there may not even be available annotations, or it has to be done manually, which makes the approach difficult to scale.

The more important drawback of the query-by-content model, however, is the fact that there is no intuitive way of describing multimedia data, and therefore there is a large gap between the user's perception or conceptual understanding of the data and the way it is actually stored and manipulated. When a query is issued against text documents, this is less of a problem because the user perceives documents as a collection of words and this is typically how the documents are represented. A search based on keywords therefore makes sense, both from the user's perspective, as well as from the system design point of view. However, in the image domain, for example, the physical image representation is very different from the mental model of the user. Therefore, the system does not really allow the user to clearly express what he/she is looking for. That ambiguity in the query specification reduces usability and naturally translates into poor retrieval effectiveness, leading to user frustration.

In light of the above problems there is a need for a different, concept-based query model.

### SUMMARY OF THE INVENTION

Disclosed is a method for querying stored multimedia data in a computer system, comprising receiving into an intermediate level a high-level concept from a user describing data to be retrieved, translating, in said intermediate level, said high-level concept into low-level queries by using system pre-defined high-level concepts, transferring said low-level queries to a low level comprising one or more search engines; said one or more search engines performing a query of the stored multimedia information using said low-level queries.

In another aspect of the method, said intermediate level comprises a set of library modules, said set of library modules comprising a concept library module for storing concepts, and one or more library modules adapted to store said data from said one or more data sources, a cataloger module adapted to construct a new concept from said high-level concept using data from said concept library and library modules, thereby creating a concept construct, and to pass said concept construct to said concept library module for storage as a concept, and an interpreter module adapted to translate said high-level concept into low-level queries using said concepts stored in said construct library and to pass said low-level queries to said one or more search engines.

In another aspect of the method, said set of library modules further comprises at least one library module selected from the group comprising a feature library module adapted to store multimedia features, a matching algorithm library module adapted to store matching algorithms, and a constraint library module adapted to store feature constraints.

In another aspect of the method, each said library module further comprises an application program interface to receive said data from a said data source.

In another aspect of the method, said cataloger module further performs the steps of selecting a set of concept features from said feature library module, selecting a set of concepts from said concept library module for use as child-concepts, and selecting a set of constraints on said child concepts from said constraint library module.

In another aspect of the method, each said concept comprises a triplet of a set of child-concepts, a set of features, and a set of relationships.

In another aspect of the method, said concepts comprise a hierarchical fuzzy graph data tree-structure comprising nodes, aggregation edges, and association edges and wherein said nodes correspond to said concepts and said features, said aggregation edges correspond to parent-child relationships, and said association edges correspond to said constraints.

In another aspect of the method, said edges are weighted.

In another aspect of the method, a matching algorithm comprises

```
GetNextMatch( ),
AssignNextMatch( ), and ShiftNextMatch( ) procedures, wherein:
  said GetNextMatch( ) procedure comprises the steps:
testqueue: if queue.Empty( ), return NULL;
head −−> queue.Pop( );
if head.Complete( ), return head,
head2 −−> head.Copy( );
head2.AssignNextMatch( );
if head2.Valid( ), queue.Push(head2);
head.ShiftNextMatch( );
queue.Push(head);
Goto testqueue;
  said AssignNextMatch( ) procedure comprises the steps:
```

child −−> GetNextUnassigned( );
child.match_ptr++;

if (child.match_ptr} == NULL), then,
child.match_ptr −−> child.GetNextMatch( );
Make child an assigned node;
said ShiftNextMatch( ) procedure comprises the steps:

Child −−> GetNextUnassigned( );
child. match_ptr++;

```
if (child.match_ptr == NULL),
then, child.match_ptr −−> child.GetNextMatch( ), wherein
variables head, head2, and child, all correspond to concept nodes;
variable queue denotes
a priority queue of the corresponding concept node;
and match_ptr is a pointer to the next
possible match for a given concept node;
Pop( ) is a method to get the next node off the
priority queue; Push( ) is a method to put a node on the priority queue;
Empty( ) is a method to check if the priority queue is empty;
Copy( ) is a method to copy a node;
Complete( ) is a method to check if the children assignment is complete;
Valid( ) is a
method to check if the children assignment meets the constraints; and
GetNextUnassigned( ) is a method to select a variable that is unassigned.
  Disclosed is a matching algorithm comprising GetNextMatch( ),
AssignNextMatch( ), and ShiftNextMatch( ) procedures, wherein:
  said GetNextMatch( ) procedure comprises the steps:
testqueue: if queue.Empty( ), return NULL;
head −−> queue.Pop( );
if head.Complete( ), return head,
head2 −−> head.Copy( );
head2.AssignNextMatch( );
if head2.Valid( ), queue.Push(head2);
head.ShiftNextMatch( );
queue.Push(head);
Goto testqueue;
  said AssignNextMatch( ) procedure comprises the steps:
```

child −−> GetNextUnassigned( );
child.match_ptr++;

if (child.match_ptr} == NULL),
then, child.match_ptr −−> child.GetNextMatch( );
Make child an assigned node;
said ShiftNextMatch( ) procedure comprises the steps:

Child −−> GetNextUnassigned( );
child.match_ptr++;

if (child.match_ptr == NULL),
then, child.match_ptr −−> child.GetNextMatch( ), wherein
variables head, head2, and child, all correspond to concept nodes;
variable queue denotes
a priority queue of the corresponding concept node;
and match_ptr is a pointer to the next
possible match for a given concept node;
Pop( ) is a method to get the next node off the
priority queue; Push( ) is a method to put a node on the priority queue;
Empty( ) is a method to check if the priority queue is empty;
Copy( ) is a method to copy a node;
Complete( ) is a method to check if the children assignment is complete;
Valid( ) is a
method to check if the children assignment meets the constraints; and
GetNextUnassigned( ) is a method to select a variable that is unassigned.

Disclosed is a program storage device readable by machine, tangibly embodying a program of instructions executable by the machine to perform method steps for querying stored multimedia data, said method steps comprising receiving into an intermediate level a high-level concept from a user describing data to be retrieved, translating, in said intermediate level, said high-level concept into low-level queries by using system pre-defined high-level concepts, transferring said low-level queries to a low level comprising one or more search engines; said one or more search engines performing a query of the stored multimedia information using said low-level queries.

In another aspect of the program storage device, said intermediate level comprises a set of library modules, said set of library modules comprising a concept library module for storing concepts, and one or more library modules adapted to store said data from said one or more data sources, a cataloger module adapted to construct a new concept from said high-level concept using data from said concept library and library modules, thereby creating a concept construct, and to pass said concept construct to said concept library module for storage as a concept, and an interpreter module adapted to translate said high-level concept into low-level queries using said concepts stored in said construct library and to pass said low-level queries to said one or more search engines.

In another aspect of the program storage device, said set of library modules further comprises at least one library module selected from the group comprising a feature library module adapted to store multimedia features, a matching algorithm library module adapted to store matching algorithms, and a constraint library module adapted to store feature constraints.

In another aspect of the program storage device, each said library module further comprises an application program interface to receive said data from a said data source.

In another aspect of the program storage device, said cataloger module further performs the steps of selecting a set of concept features from said feature library module, selecting a set of concepts from said concept library module for use as child-concepts, and selecting a set of constraints on said child concepts from said constraint library module.

In another aspect of the program storage device, said each said concept comprises a triplet of a set of child-concepts, a set of features, and a set of relationships.

In another aspect of the program storage device, said concepts comprise a hierarchical fuzzy graph data tree-structure comprising nodes, aggregation edges, and association edges and wherein said nodes correspond to said concepts and said features, said aggregation edges correspond to parent-child relationships, and said association edges correspond to said constraints.

In another aspect of the program storage device, said edges are weighted.

In another aspect of the program storage device, a matching algorithm comprises GetNextMatch( ), AssignNextMatch( ), and ShiftNextMatch( ) procedures, wherein:

said GetNextMatch( ) procedure comprises the steps:

testqueue: if queue.Empty( ), return NULL,
head −−> queue.Pop( );
if head.Complete( ), return head;
head2 −−> head.Copy( );
head2.AssignNextMatch( );
if head2.Valid( ), queue.Push(head2);
head.ShiftNextMatch( );
queue.Push(head);
Goto testqueue;
said AssignNextMatch( ) procedure comprises the steps:

child −−> GetNextUnassigned( );
child.match_ptr++;

if (child.match_ptr} == NULL),
then, child.match_ptr −−> child.GetNextMatch( );
Make child an assigned node;
said ShiftNextMatch( ) procedure comprises the steps:

Child −−> GetNextUnassigned( );
child.match_ptr++;

if(child.match_ptr == NULL),
then, child.match_ptr −−> child.GetNextMatch( ), wherein
variables head, head2, and child, all correspond to concept nodes;
variable queue denotes
a priority queue of the corresponding concept node;
and match_ptr is a pointer to the next
possible match for a given concept node;
Pop( ) is a method to get the next node off the
priority queue; Push( ) is a method to put a node on the priority queue;
Empty( ) is a method to check if the priority queue is empty;
Copy( ) is a method to copy a node;
Complete( ) is a method to check if the children assignment is complete;
Valid( ) is a
method to check if the children assignment meets the constraints; and
GetNextUnassigned( ) is a method to select a variable that is unassigned.

### BRIEF DESCRIPTION OF THE DRAWINGS

FIG. 1 depicts an overview of the invention.

FIG. 2 depicts an embodiment of the architecture of the invention.

FIG. 3 shows an example of a semantic concept.

FIG. 4 illustrates an algorithm of the invention for the query.

FIG. 5 depicts a block diagram of an algorithm for fuzzy joins.

FIG. 6 depicts an example of a fuzzy join problem.

### DETAILED DESCRIPTION OF PREFERRED EMBODIMENTS

This invention introduces a generalized query framework utilizing concept-based querying and proposes a rich representation for the concepts. In addition to improving usability, the invention enhances query power due to the support of complex constraints, and formulates the most general concept representation that can be supported efficiently by the system. By supporting arbitrary features and constraints in the definitions of concepts, an efficient method for searching of multimedia data with powerful concept definitions is established.

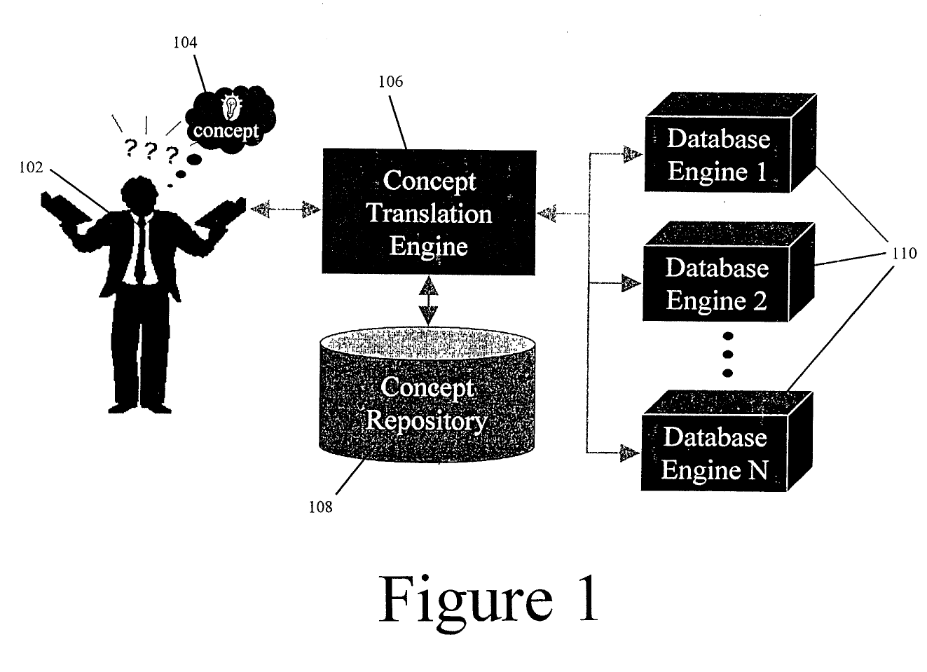

Referring to FIG. 1, there is depicted an embodiment of the invention wherein there is introduced an intermediate level of functionality in the form of a concept translation engine 106 between a user's concept 104 of stored multimedia objects and a database system's actual low-level internal representations of those objects as seen by one or more search engines 110, 112, 114. The user 102 specifies a high-level concept 104 for each database query and the concept translation engine 106 translates the concept 104 into low-level features stored in a concept repository 108. The concept translation engine 106 also performs an enhanced content-based query by passing the low-level features to the underlying database search engines 110-114 to use as the search criteria. The system allows the user to reuse a rich set of predefined semantic concepts without having to define or express them explicitly and provides a flexible mechanism for combining such concepts into even higher level composite concepts via inter-concept relationships (or constraints), thus enabling the user to express powerful queries with an interface close to his mental model.

The novel intermediate level 106 makes the mechanics of the actual search transparent to the user 102, without limiting the user's power in specifying relevant features and constraints. The system provides a uniform and natural API for specifying query concepts, which are then internally translated to the specific search engines' (110 through 114) specifications. This modularized design provides a simplified interface and improved usability, while preserving, or even enhancing, the power of content-based search.

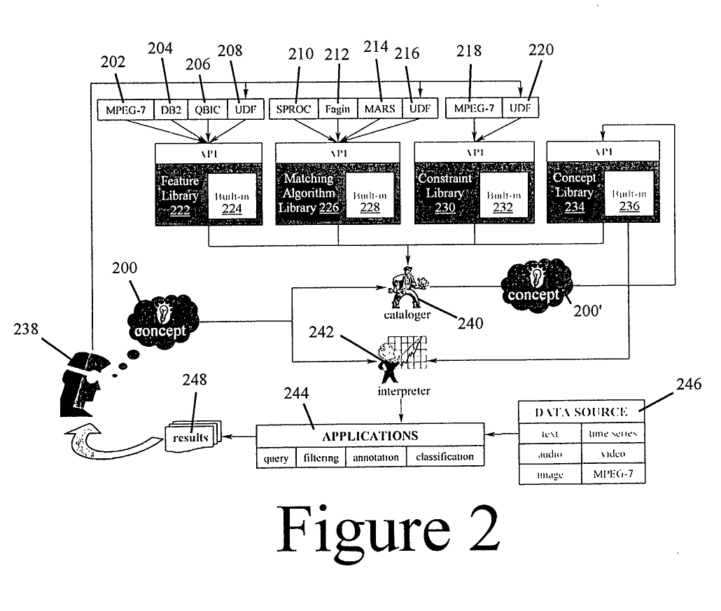

Referring to FIG. 2, there is shown an embodiment of the invention that unifies searches, joins, and nested views, allowing any of them to be crisp or fuzzy. The database system combines and generalizes query models for both structured and non-structured data and is based on the query-by-concept paradigm, where concepts are essentially generalized views and are represented by a fuzzy hierarchical graph data structure.

The specific details of the concept representation are discussed below and the design is general enough that it allows arbitrary user-defined features, constraints, and matching algorithms to be plugged in the framework. The same concept representation is used for describing both queries and data so there is a unified query language and data annotation language. The internal concept representation can be mapped to and from SQL and XML. The newly emerging MPEG-7 meta-data standard (based on XML) may be utilized as the interface to the concept representation. By adopting MPEG-7 as the concept definition language, one automatically inherit tools for expressing, manipulating, interpreting, and querying MPEG-7 descriptions. For example, the MPEG-7 Visual Annotation Tool developed by IBM can be used as a visual query interface to the proposed framework.

Architecture

Referring more specifically to FIG. 2, there are provided a set of library modules 222, 226, 230, 234 that collectively are used to define concepts. Once defined, concepts can be used in a variety of applications 244 such as querying, filtering, annotation, and classification, among others. The library modules 222, 226, 230, 234 thereby are part of an intermediate layer between the user's application and the actual search engines. The database system utilizes one or more application program interfaces (APIs) to exploit date from a variety of sources, such as data from heterogeneous sources 202-208, from different matching (or join) algorithms 210-216, and from arbitrary constraints 218 and 220, including user-defined constraints 220. Generally, a library module will be provided for each type of data source, hence there is shown a feature library module 222, a matching algorithm library module 226, and a constraint library module 230.

The feature library 222 contains a set of features, such as color histograms, textures, shape, motion, and the like that may be thought of as concept attributes and may derive from various sources, such as traditional databases 204, multimedia search engines 206, MPEG-7 annotated data 202, and the like. The types of features may correspond to MPEG-7 descriptors and description schemes, or may be user defined 208 through the API. The feature library 222 may also contain a list of primitive built-in features 224 such as those corresponding to atomic data types. In a sense, the feature library reflects the capabilities of the underlying search engines. For example, if the system uses query-by-image-content (QBIC) 206 to extract a particular type of texture feature, then that feature would be present in the library so that concepts can reflect searches on that feature. Treating all features in such a unified manner provides more power to the system because concepts can use the capabilities of multiple back-end search engines transparently to the user.

The matching algorithm library 226 comprises a set of join algorithms having the same interface that each take an ordered set of matches for a set of children concepts and compute an ordered set of matches for a parent concept defined through the children. In this process, all algorithms ensure that any constraints defined in the parent concept are met when combining the results from the child concepts. Examples of such join algorithms include Fagin's algorithm 212, which is described in detail in R. Fagin, FUZZY QUERIES IN MULTIMEDIA DATABASE SYSTEMS, Proc. of the 1998 ACM SIGACT-SIGMOD-SIGART Symposium on Principles of Database Systems (1998); and R. Fagin, COMBINING FUZZY INFORMATION FROM MULTIPLE SYSTEMS, Journal of Computer and System Sciences, 58:83-99, 1999 [an extended abstract of which appears in Proc. Fifteenth ACM Symp. on Principles of Database Systems (PODS '96), Montreal, pp. 216-226 (1996)]; the disclosures of all of which are incorporated by reference herein in their entirety. Another example of a join algorithm is the MARS query tree algorithm 214, which is described in detail in M. Ortega et al., INFORMATION RETRIEVAL OVER MULTIMEDIA DOCUMENTS, Technical Report TR-MARS-99-11, University of California, Irvine, Calif., (1999); and M. Ortega et al., SUPPORTING RANKED BOOLEAN SIMILARITY QUERIES IN MARS, IEEE Trans. on Knowledge and Data Engineering, 10, November-December (1998), the disclosures of all of which are incorporated by reference herein in their entirety. Yet another join algorithm useful with the invention is the SPROC algorithm 210, which is described in detail in C. S. Li, J. R. Smith et al., SEQUENTIAL PROCESSING FOR CONTENT-BASED RETRIEVAL OF COMPOSITE OBJECTS, Storage and Retrieval of image and Video Databases, VI, SPIE (1998), the disclosures of which are incorporated by reference herein in their entirety.

The Fagin and MARS algorithms do not really work with any constraints but simply provide Boolean conjunction and disjunction, while the SPROC algorithm allows arbitrary fuzzy constraints. Other algorithms 216 can be specified as long as they conform to the established interface. The matching algorithm library 226 can also contain a list of pre-implemented algorithms 228.

The constraint library 230 is simply a collection of constraints, or relationships, defined on a single feature. Examples include spatial or temporal constraints, feature similarity constraints, and the like. The library has an API so that users can define their own constraints by specifying the feature they apply to, as well as the number of arguments (or concepts) that they relate. It also has a set of built-in constraints 232 that are pre-defined in the system.

Finally, the concept library 234 contains a list of pre-defined concepts 236 either built into the system as shown, shipped as concept library plug-in modules, or previously defined by users, or a combination thereof. The process of defining new concepts is performed by a concept cataloger module 240, and comprises the following steps: (1) selecting a set of concept features from the feature library module 222; (2) selecting a set of child concepts from the concept library module 234; and (3) selecting a set of constraints on the child concepts from the constraint library module 230. Any of these sets can be empty. The combination of the specified child concepts, along with the relationships among them, form a concept construct 200′ with the specified features. The concept construct 200′ is then inserted in the concept library 234 as a new concept for later reuse.

Given a set of pre-defined concepts stored away in the concept library module, an application 244 can then use a concept-based interface wherein any input concepts 200 are looked up in the concept library 234 by a concept interpreter 242 and translated into the corresponding features, sub-concepts, and constraints. Those components are then used to form low-level queries to the search engines and the results 248 are aggregated back from the data sources 246 using the specified join algorithms, and presented to the user 238. The concept cataloger 240, concept interpreter 242, and the concept library 234, have similar functionality as the corresponding modules in the CAMEL system described in A. Natsev et al., CAMEL: CONCEPT ANNOTATED IMAGE LIBRARIES, Storage and Retrieval for Image and Video Databases, San Jose, Calif., SPIE (January 2001), the disclosures of which are incorporated by reference herein in their entirety. However, because of the more complex concept representation model of the invention, here they are more sophisticated and make use of added feature 222, constraint 230, and matching algorithm 226 libraries.

Concepts

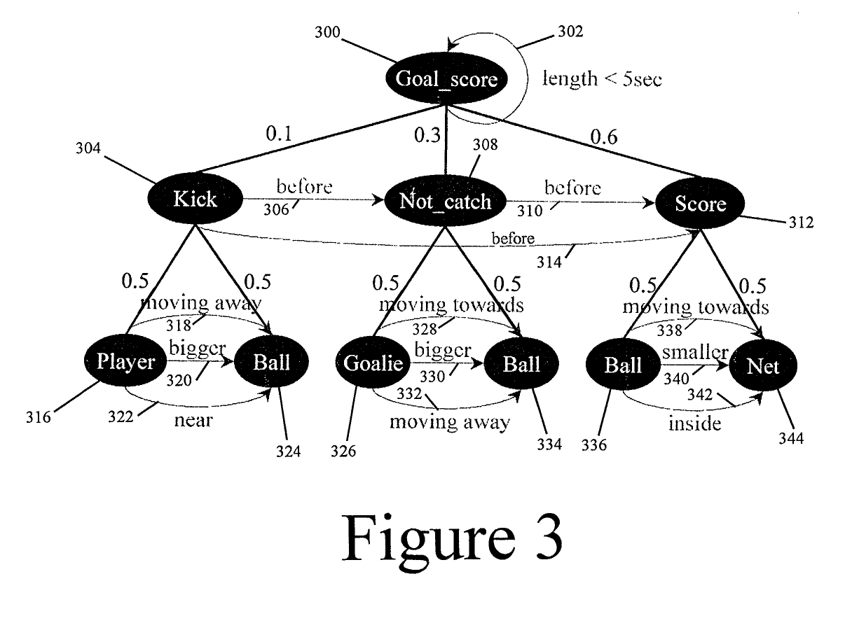

Referring to FIG. 3, there is shown an embodiment of the invention wherein concepts are defined recursively. Each concept may be defined as a triplet C, F, R, wherein C denotes a set of children concepts (e.g., objects, like car), F denotes a set of features (e.g., color, shape, texture, etc.), and R denotes a set of relationships (e.g., constraints, such as to the left-of or near) among elements of C. When C, and therefore R, are the empty sets, the resulting concepts are described as primitive, otherwise they are referred to as composite. Intuitively, primitive concepts represent basic multimedia entities, such as image regions (defined by spatial location and shape, or by homogeneity constraint on a color or texture feature), video segments (specified by a time interval in the video sequence), and the like. Composite objects (or higher-level semantic concepts) are then derived from lower-level ones by imposing inter-object constraints upon them.

In FIG. 3 there is depicted a hierarchical fuzzy graph data structure that resembles a tree-structured graph. Nodes in the representation correspond to concepts, and contain features as well as constraints. There are two types of edges in the data structure: aggregation edges, representing parent-child relationships, and association edges, representing inter-sibling constraints. Note that for simplicity, the association edges only represent binary relationships although the actual representation allows n-ary constraints in general. The aggregation edges also have associated weights, reflecting the relative importance of the child concepts in the parent's definition. One could add weights to the association edges as well, but, for purposes of simplifying this example, all constraints will be treated as being equally important. The tree structure shown is amenable to computer database representation, wherein the nodes may be embodied as blocks of data and the edges as pointers or handles thereto.

FIG. 3 illustrates an example of the concept of scoring a goal in a soccer game, represented at the topmost node 300. The concept is defined as a sequence of three events represented by three nodes: a player kicking the ball 304, the goal-keeper not catching the ball 308, and the ball entering the goal 312. These events are themselves concepts defined recursively by means of primitive concepts, namely player 316; ball 324, 334, 336; net 344; and goalie 326. The relationships that make sense in this scenarios are a temporal ordering 306, 310, 314 of the higher level events 304, 308, 312, as well as several spatial 322 342, scale 320, 330, 340, and motion constraints 318, 328, 338, 332 on the primitive concepts (i.e., ball moving away from player, ball inside the net, etc.). Overall, there may be implemented a time constraint 302 on the total length of the sequence (the three events need to occur in a relatively short period of time for them to be significant). One could also express the time constraint as a sequence of proximity constraints on the time stamps of the three higher level events 304, 308, 312.

Weight factors, 0.1, 0.3, and 0.6, on the edges represent the relative importance of the concepts with respect to their siblings. Note that in the definition of the top-level concept 300 neither of its first two child concepts 304 or 308 are absolutely mandatory. For example, a player may head the ball into the net rather than kicking it, or the goalie may not even be near the ball at the time of a kick so that there would be no attempt to catch the ball. The only required event is that the ball enters the net 312 and so it has the highest weight of the three child events, namely 0.6. The other two sub-concepts 304 and 308 are appropriately weighted so that the less relevant (or further in distance or time) an event is from the critical scoring event, the less weight it has. On the other hand, in the recursive definition at the leaf level, all primitive concepts are necessary for the definition of the parent ones and are therefore weighted as equally important (i.e., weight 0.5 for each).

Concept Matching Algorithms

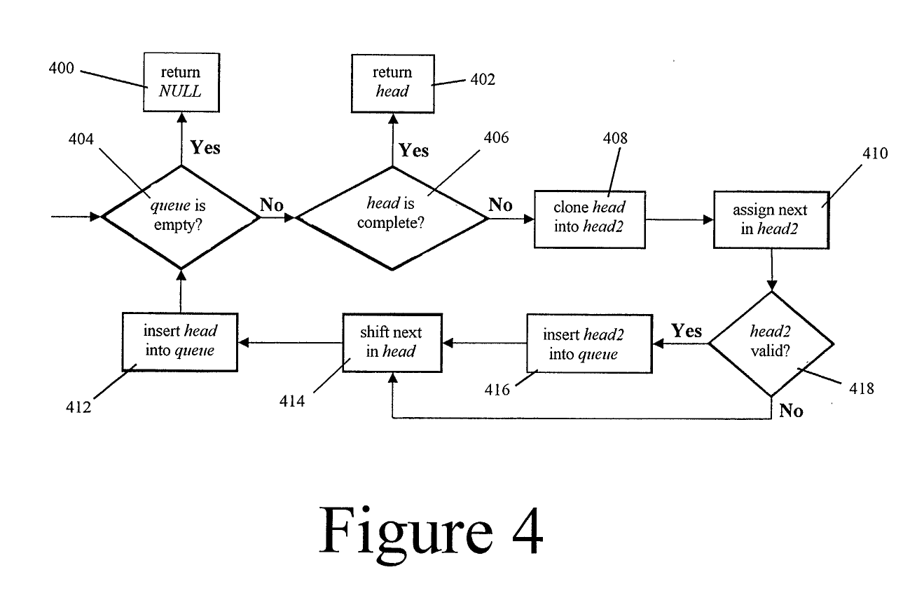

The concept matching, or fuzzy join, algorithm of the invention is based on the A* search algorithm and its variations, well known in the Artificial Intelligence (AI) art. Assume a concept C derived by joining several children concepts C₁, . . . , Cₙ. All children nodes are treated as variables, and the list of matches for each node as the list of possible values it can take. Therefore, the problem of finding a valid match combination with maximum score reduces to the problem of finding an assignment for the children nodes, subject to a list of constraints, that maximizes the score. Because each possible value for a variable corresponds to a score, the score of an assignment is simply the aggregation of the individual scores. For assignments that are complete (that is, all children variables have assigned values), the score is unique. For incomplete assignments, the score can be upper-bounded by taking an upper boundary (e.g., a value of 1.0) for the individual score of every unassigned variable. If the items are scanned in decreasing order of their scores, one can simply take the score value of the previous item as an upper-bound estimate of the next score value. Referring to FIG. 4, this provides a heuristic creating an upper bound for the score of incomplete assignments, such as may be represented in pseudocode, for example:

Procedure GetNextMatch( ):

| | | |
|---|---|---|
| testqueue: | if queue.Empty( ) | (block 404) |
| | return NULL | (block 400) |
| | head −−> queue.Pop( ) | |
| | if head.Complete( ) | (block 406) |
| | return head | (block 402) |
| | head2 −−> head.Copy( ) | (block 408) |
| | head2.AssignNextMatch( ) | (block 410) |
| | if head2.Valid( ) | (block 418) |
| | queue.Push(head2) | (block 416) |
| | head.ShiftNextMatch( ) | (block 414) |
| | queue.Push(head) | (block 412) |
| | Goto testqueue | |

where the methods AssignNextMatch( ) and
ShiftNextMatch( ) may be executed as follows:
Procedure AssignNextMatch( ):

child −−> GetNextUnassigned( )
child.match_ptr++
if (child.match_ptr} == NULL), then

child.match_ptr −−> child.GetNextMatch( )

Make child an assigned node
Procedure ShiftNextMatch( ):

Child −−> GetNextUnassigned( )
child.match_ptr++

if (child.match_ptr == NULL), then

child.match_ptr −−> child.GetNextMatch( )

where the variables head, head2, and child,
all correspond to concept nodes; the queue
variable denotes the priority queue of the corresponding concept node;
and the match_ptr is simply a pointer to the next possible match for a
given concept node. The priority queue supports operations Pop( ),
Push( ), and Empty( ), which are self-explanatory. The
concept nodes have methods Copy( ),
Complete( ) (for checking if the children assignment is complete),
Valid( ) (for checking if the children assignment meets the
constraints), GetNextUnassigned( )
(for selecting a variable that is unassigned), and the
methods listed, namely GetNextMatch( ),
ShiftNextMatch( ), and AssignNextMatch( ).

Preferably, there will be maintained a priority queue of all possible assignments (complete and incomplete) ordered by the upper-bound estimate of their scores. Assignments may then be processed from the top of the queue until the head corresponds to a complete assignment. If that is the case, all incomplete assignments will have scores smaller than the complete assignment at the head of the queue, and therefore, that assignment corresponds to the next best answer. During the processing loop, the algorithm simply takes the head of the queue, selects one unassigned variable, and creates two new assignments. The first one is identical to the original assignment, except that the chosen variable is now assigned to the next possible match. The second one is similar but it simply moves the pointer to the next available match without assigning the variable. This allows the algorithm to later backtrack and consider the other possible matches for the chosen variable. Both assignments are inserted back into the priority queue according to their new score estimates if and only if they satisfy the constraints.

One important property to note from the above pseudocode is the recursive invocation of method GetNextMatch( ) from methods ShiftNextMatch( ), and AssignNextMatch( ). This is why the algorithm works on hierarchy of concepts—when computing the next best match for a concept at level L, the algorithm recursively invokes the same subroutine for some of the children at level L+1, where increasing levels correspond to deeper levels in the tree. This recursive mechanism enables nested concepts like the ones in FIG. 3 to be matched efficiently. The efficiency comes from the fact that the recursive call is executed only if needed, using a pull-based model (i.e., a demand-driven paradigm). The heuristic of processing nodes in order of their score estimates essentially tries to minimize the recursive invocations only to the ones that are really necessary. In contrast, a naive approach—typically used for crisp joins in databases—would compute all matches at all children nodes before it starts materializing the matches at the parent node.

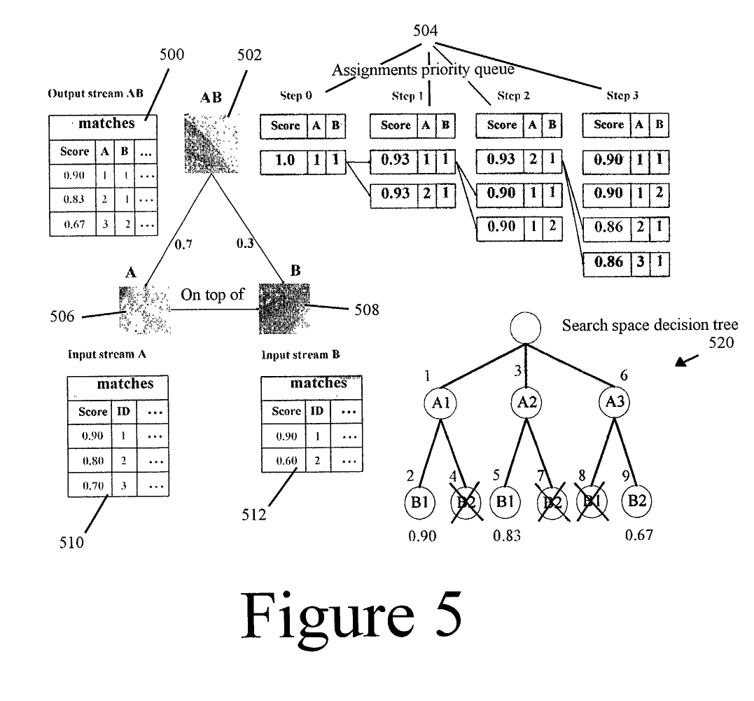

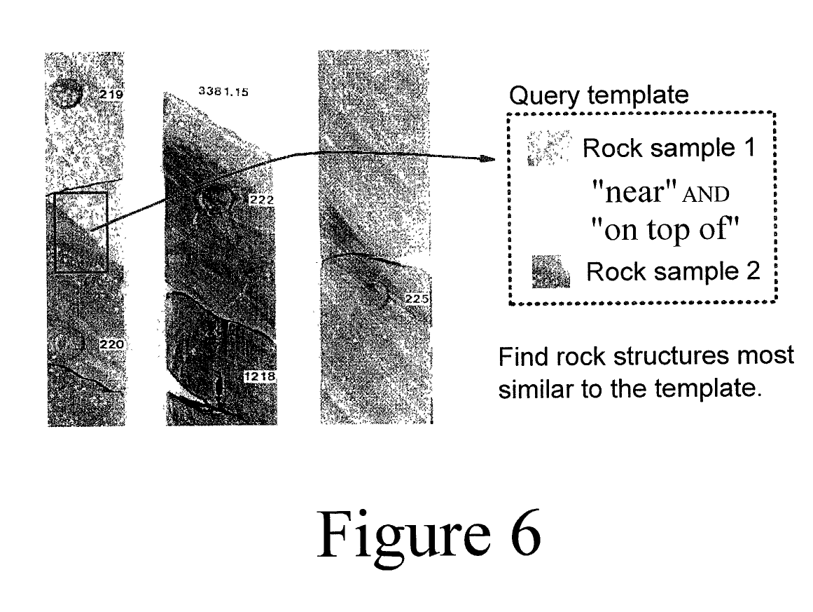

Referring to FIGS. 5 and 6, the algorithm of the invention is illustrated for the oil exploration example set forth below. Assume two concepts, A and B, to join (506 and 508), and the score aggregation function is simply the weighted average of the two scores, with weights 0.7 and 0.3. Concept A (506) contains three possible instances 510 and concept B (508) has only two instances 512. Suppose also that the on-top-of constraint of the example in FIG. 6 is satisfied only for matching combinations (A1, B1), (A2, B1), (A3, B2). The final solutions are listed in the top left corner 500 of the figure, while the top right corner shows the first four iterations of priority queue processing 504 (until the top answer is identified). Each assignment in the priority queue 504 contains a score estimate and an ID of the next possible instance from concept A or B, respectively. The unshaded squares denote unassigned variables and score estimates, while the shaded squares contain variable assignments and exact scores. The lower right corner contains the decision tree 514 for the search process, with each node corresponding to a variable assignment (A1-A3 and B1-B2). The nodes in the tree denote all possible variable assignments and the numbers (1-9) next to the nodes denote the order in which the corresponding node will be visited by the search algorithm. Note that even though the branch of the tree corresponding to the best answer (A1, B1) will be traversed at step 2, it will not be output as the best answer until step 3, when it will appear at the head of the queue 504. The crossed out terminal nodes correspond to invalid overall assignments, and the numbers below the other terminal nodes correspond to their aggregated scores.

The hierarchical nature of the algorithm is illustrated in FIG. 4 for a single join level only. If we had multiple join levels, as in FIG. 3, the matches returned for the AB node 502, for example, would become part of the assignments priority queue 504 at the parent node. In that case, the steps in FIG. 4 will be executed each time the parent node needs to get the next match for the AB node 502. Note that the GetNextMatch( ) method can be implemented in different ways at any node in the query tree so that an arbitrary user-defined algorithm can be plugged instead. For example, if the join type is known to be uniquely constrained, we may plug in Fagin's or MARS algorithm or an equivalent. If it is a join with fuzzy constraints, then we could use SPROC or an equivalent. This makes the proposed framework and algorithm very powerful tools for solving real-world problems.

Concept Matching Problem Complexity and Alternatives

In the case of joins with crisp constraints, we cannot guarantee polynomial time but we can trade the correctness of the algorithm for a running time guarantee. Heuristics that can limit the running time by approximating the optimal answer will be found useful in the invention and are as follows:

fixed length—the simplest heuristic that limits the size of the priority queue to a certain fixed threshold T so that the total running time is polynomial. The threshold may vary for each query but is the same for all nodes within a query tree. For example, it may be polynomial in the number k of desired answers, or proportional to the expected number of matches to be scanned from each fuzzy stream. If the queue length is set sufficiently liberally, this should not affect the correctness in most cases because the assignments that will be discarded will be the ones with the lowest score estimates.

fixed rank—this is a heuristic that is largely similar to the above one but has the following distinction. With the fixed length heuristic, when an attempt is made to insert a new complete or partial solution to the priority queue, the attempt will fail if the current queue size has reached the threshold. With the fixed rank heuristic, an additional check will be made to compare the score of the last item in the queue with the one of the new solution. If the new one is higher, then it will be inserted in the queue after deleting the last queue element first. Thus, this heuristic tries to maintain a queue of items with rank smaller than the given threshold. Because the ultimate goal is to output the items according to their final rank, this heuristic is more promising than the previous one.

fixed score—this heuristic allows the queue length to vary so long as all the assignments in the queue have score estimates above a certain threshold T. Again, the score cut-off threshold may vary for different queries, but will preferably be fixed within a single query. For example, we may set the threshold to 0.5 so that all assignments with a lower score estimate are disregarded. In practice, this should not affect the correctness of the result although it is theoretically possible that an assignment that was discarded by the heuristic at level i should appear in a good solution at level i−1 (i.e., the level above) simply because it was the only assignment that satisfied all the constraints.

fixed gap—this heuristic enforces the gap between the scores of the first and last item in the queue to be less than a certain threshold T. This heuristic is equivalent to the fixed score heuristic above if the top assignment has a score of 1.0. In other cases, it compensates for skewed (i.e., very small) scores by comparing the candidate score relative to the current top score. Thus, given the same threshold, this heuristic is more liberal than the above one and allows more assignments to be considered. For example, the threshold may be set to discard assignments that have scores smaller than the top score by at least 0.5.

fixed ratio—this heuristic enforce the ratio between the scores of the first and last item in the queue to be less than a certain threshold T. This is similar to the fixed gap heuristic but it considers the relative score difference rather than the absolute one (e.g., drop assignments that have scores more than 100 times smaller than the top score).

variable threshold—this heuristic is a more complicated counterpart for the above heuristics, wherein the thresholds vary in accordance to run-time statistics, selectivity estimation, or other methods for dynamic threshold estimation. Those may include estimates on the number of items that will need to be scanned from each stream using results from Fagin's approach, for example. Another embodiment is to convert the top-k query into a score range query using selectivity statistics. Using the children weights, and a best-case estimate on matches, we could propagate the score ranges from the root down the concept tree by estimating the children's score ranges from the parent's one. Each node will then get a different threshold value that will be used to cut off the size of the priority queue.

### EXAMPLE

Referring to FIG. 6, an example demonstrating the workings of the invention is the match of strata structures across boreholes in oil exploration. Petroleum companies selectively drill boreholes in oil-rich areas in order to estimate the size of underground oil reservoirs. Instrument readings of physical parameters, such as conductivity, as well as images of rock samples from the borehole, are indexed by depth, as in the example shown in FIG. 6. Traditionally, experienced human interpreters (usually geologists) will label the rock samples and try to co-register the labels of one borehole with those of many other boreholes in the neighboring area. The matched labels are then fed into 3-D modeling software to reconstruct the strata structure underground, from which the reservoir size is deduced.

The process of rock layer labeling and cross-bore co-registration can be significantly accelerated by content-based image retrieval techniques. An interpreter can issue a query to locate similar looking rock layers in all borehole images. Consider the example in FIG. 6 where the query template comprises two rock types. The query specifies their spatial relations to be “near” and one “on top of” the other.

This scenario is an example of combining the results of two fuzzy searches using constraints that are both crisp (rock A is above rock B) and fuzzy (rock A is near rock B). We call such queries “fuzzy joins” with “crisp and fuzzy constraints”. According to the type of search results to be joined (crisp or fuzzy) and the type of constraints used for the join (again, crisp or fuzzy), we can have four join combinations. Of those, currently available database systems typically support only the crisp joins with crisp constraints. When it comes to introducing any fuzziness, such database systems are very inefficient at best, or completely unusable at worst. The multimedia search systems, on the other hand, support fuzziness in the searches themselves but either do not really allow any joins of the search results, or support the joins in a very limited and domain-specific scope.

Another feature that receives very limited support in both traditional and multimedia databases is the definition of nested (or recursive) views of fuzzy result sets. For example, building on the above application scenario, we can define the concept of DELTA_LOBE as a sequence of SANDSTONE on top of SHALE on top of SILTSTONE. The concepts of SANDSTONE, SHALE, and SILTSTONE, can be recursively defined by specifying samples of rock textures that fall in the corresponding class. Using the previously defined views for SANDSTONE, SHALE, and SILTSTONE, one might want to define DELTA LOBE view using the following SQL statement:

| CREATE VIEW DELTA_LOBE AS | |
|---|---|
| SELECT * | |
| FROM | SANDSTONE SD, SHALE SH, SILTSTONE SL |
| WHERE | ABOVE(SD.DEPTH, SH.DEPTH) = 1 AND |
| | ABOVE(SH.DEPTH, SL.DEPTH) = 1 AND |
| | NEAR(SD.DEPTH, SH.DEPTH) = 1 AND |
| | NEAR(SH.DEPTH, SL.DEPTH) = 1 |

Even though conceptually there is nothing new in this definition, in practice it is very hard to support such nested fuzzy views efficiently. The reason is that due to the fuzziness, getting even a single candidate from the top view may involve scanning all candidates of the child views, which would be very time consuming. An algorithm for determining the best match from the top view would require examining all possible combinations of matches from the children views in order to compute their scores.

On the other hand, there are numerous application scenarios that, like the one above, can benefit greatly from fuzzy searches, fuzzy joins, and fuzzy nested views. In addition to searching, such technology can be used for filtering, annotation, classification, and inferencing purposes, among others. For example, selecting a proper helicopter landing space for a forest fire may involve a satellite image search with constraints on landing space size and flatness, proximity to water sources and to the fire itself. The decision to buy a house in a certain area may include criteria about proximity to schools or hospitals, termite populations, as well as demographic factors. Ideally, all of these criteria should be incorporated into a single query where the system will perform separate queries to different sub-systems and will integrate the results according to the specified criteria. The range of application domains that can benefit from a single unified view that incorporates both fuzzy and crisp queries, as well as their joins and nested views, include entertainment videos (e.g., movies, news and sports feeds, etc.); aerial, satellite, seismic, or medical imagery; time series and stock marked data; e-commerce for personalized virtual product catalogs; and music shopping, among others.

As can be seen, the invention solves the problem of joining multiple fuzzy result sets where the join condition is expressed as a list of arbitrary constraints on the result tuples and can do so to hierarchies of such constrained fuzzy joins. The invention is useful in important multimedia applications and demonstrates superior performance over conventional structured-query models, as well as query-by-content models.

In can be seen that the algorithms of the invention enable high-level querying of multimedia data by imposing arbitrary domain-specific constraints among multimedia objects and is at least as efficient as Fagin's state-of-the-art fuzzy join algorithm for uniquely constrained fuzzy joins, or joins based on identical keys. However, the invention also generalizes to Cartesian join scenarios that are unsupported in the art. In particular, the invention can support joins with fuzzy and crisp constraints. It is also suitable for handling multiple levels of abstraction, or concept hierarchies, which is typical of concepts arising from multimedia databases. The invention may be modified with one of several heuristics for trading off correctness (i.e., lack of false dismissals) for execution time.

It is to be understood that all physical quantities disclosed herein, unless explicitly indicated otherwise, are not to be construed as exactly equal to the quantity disclosed, but rather about equal to the quantity disclosed. Further, the mere absence of a qualifier such as “about” or the like, is not to be construed as an explicit indication that any such disclosed physical quantity is an exact quantity, irrespective of whether such qualifiers are used with respect to any other physical quantities disclosed herein.

While preferred embodiments have been shown and described, various modifications and substitutions may be made thereto without departing from the spirit and scope of the invention. Accordingly, it is to be understood that the present invention has been described by way of illustration only, and such illustrations and embodiments as have been disclosed herein are not to be construed as limiting to the claims.

What is claimed is:

1. A method for querying stored multimedia data in a computer system, comprising:
receiving into an intermediate level a high-level concept from a user describing data to be retrieved;
translating, in said intermediate level, said high-level concept into low-level queries by using system pre-defined high-level concepts; and
transferring said low-level queries to a low level comprising one or more search engines; said one or more search engines performing a query of the stored multimedia information using said low-level queries.

2. The method of claim 1 wherein said intermediate level comprises:
a set of library modules, said set of library modules comprising:
a concept library module for storing concepts;
one or more library modules adapted to store said data from said one or more data sources;
a cataloger module adapted to construct a new concept from said high-level concept using data from said concept library and library modules, thereby creating a concept construct, and to pass said concept construct to said concept library module for storage as a concept; and
an interpreter module adapted to translate said high-level concept into low-level queries using said concepts stored in said construct library and to pass said low-level queries to said one or more search engines.

3. The method of claim 2 wherein said set of library modules further comprises at least one library module selected from the group comprising:
a feature library module adapted to store multimedia features;
a matching algorithm library module adapted to store matching algorithms; and
a constraint library module adapted to store feature constraints.

4. The method of claim 3 wherein each said library module further comprises an application program interface to receive said data from a said data source.

5. The method of claim 3 wherein said cataloger module further performs the steps of:
selecting a set of concept features from said feature library module;
selecting a set of concepts from said concept library module for use as child-concepts; and
selecting a set of constraints on said child concepts from said constraint library module.

6. The method of claim 1 wherein said each said concept comprises a triplet of a set of child-concepts, a set of features, and a set of relationships.

7. The method of claim 6 wherein said concepts comprise a hierarchical fuzzy graph data tree-structure comprising nodes, aggregation edges, and association edges and wherein:
said nodes correspond to said concepts and said features;
said aggregation edges correspond to parent-child relationships; and
said association edges correspond to said constraints.

8. The method of claim 7 wherein said edges are weighted.

9. The method of claim 3 further comprising a matching algorithm comprising GetNextMatch( ), AssignNextMatch( ), and ShiftNextMatch( ) procedures, wherein:
said GetNextMatch( ) procedure comprises the steps:

| testqueue: | if queue.Empty( ); |
|---|---|
| | return NULL, |
| | head −−> queue.Pop( ); |
| | if head.Complete( ); |
| | return head; |
| | head2 −−> head.Copy( ); |
| | head2.AssignNextMatch( ); |
| | if head2.Valid( ); |

queue.Push(head2);
head.ShiftNextMatch( );
queue.Push(head);
Goto testqueue;
said AssignNextMatch( ) procedure comprises the steps:
child −−> GetNextUnassigned( );
child.match_ptr++;
if(child.match_ptr} == NULL), then;
child.match_ptr −−> child.GetNextMatch( );
Make child an assigned node;
said ShiftNextMatch( ) procedure comprises the steps:
Child −−> GetNextUnassigned( );
child.match_ptr++;
if(child.match_ptr == NULL), then;
child.match_ptr −−> child.GetNextMatch( );
wherein variables head, head2, and child,
all correspond to concept nodes;
variable queue denotes a priority queue of the
corresponding concept node; and
match_ptr is a pointer to the next possible match for
a given concept node; Pop( ) is a
method to get the next node off the priority queue;
Push( ) is a method to put a node on
the priority queue; Empty( ) is a method to check
if the priority queue is empty; Copy( ) is
a method to copy a node; Complete( ) is a method to
check if the children assignment is
complete; Valid( ) is a method to check if the children
assignment meets the constraints;
and GetNextUnassigned( ) is a method to select a
variable that is unassigned.
10. A matching algorithm comprising GetNextMatch( ),
AssignNextMatch( ),
and ShiftNextMatch( ) procedures, wherein:
said GetNextMatch( ) procedure comprises the steps:
testqueue: if queue.Empty( );
return NULL,
head −−> queue.Pop( );
if head.Complete( );
return head;
head2 −−> head.Copy( );
head2.AssignNextMatch( );
if head2.Valid( );
queue.Push(head2);
head.ShiftNextMatch( );
queue.Push(head);
Goto testqueue;
said AssignNextMatch( ) procedure comprises the steps:
child −−> GetNextUnassigned( );
child.match_ptr++;
if(child.match_ptr} == NULL), then;
child.match_ptr −−> child.GetNextMatch( );
Make child an assigned node;
said ShiftNextMatch( ) procedure comprises the steps:
Child −−> GetNextUnassigned( );
child.match_ptr++;
if(child.match_ptr == NULL), then;
child.match ptr −−> child.GetNextMatch( );
wherein variables head, head2, and child,
all correspond to concept nodes;
variable queue denotes a priority queue of
the corresponding concept node; and
match_ptr is a pointer to the next possible match for a
given concept node; Pop( ) is a
method to get the next node off the priority queue;
Push( ) is a method to put a node on
the priority queue; Empty( ) is a method to check if the
priority queue is empty; Copy( ) is
a method to copy a node; Complete( ) is a method to
check if the children assignment is
complete; Valid( ) is a method to check if the children
assignment meets the constraints;
and GetNextUnassigned( ) is a method to select a
variable that is unassigned.

11. A program storage device readable by machine, tangibly embodying a program of instructions executable by the machine to perform method steps for querying stored multimedia data, said method steps comprising:
receiving into an intermediate level a high-level concept from a user describing data to be retrieved;
translating, in said intermediate level, said high-level concept into low-level queries by using system pre-defined high-level concepts;
transferring said low-level queries to a low level comprising one or more search engines; said one or more search engines performing a query of the stored multimedia information using said low-level queries.

12. The apparatus of claim 11 wherein said intermediate level comprises:
a set of library modules, said set of library modules comprising:
a concept library module for storing concepts; and
one or more library modules adapted to store said data from said one or more data sources;
a cataloger module adapted to construct a new concept from said high-level concept using data from said concept library and library modules, thereby creating a concept construct, and to pass said concept construct to said concept library module for storage as a concept; and
an interpreter module adapted to translate said high-level concept into low-level queries using said concepts stored in said construct library and to pass said low-level queries to said one or more search engines.

13. The apparatus of claim 12 wherein said set of library modules further comprises at least one library module selected from the group comprising:
a feature library module adapted to store multimedia features;
a matching algorithm library module adapted to store matching algorithms; and
a constraint library module adapted to store feature constraints.

14. The apparatus of claim 13 wherein each said library module further comprises an application program interface to receive said data from a said data source.

15. The apparatus of claim 13 wherein said cataloger module further performs the steps of:
selecting a set of concept features from said feature library module;
selecting a set of concepts from said concept library module for use as child-concepts; and
selecting a set of constraints on said child concepts from said constraint library module.

16. The apparatus of claim 11 wherein said each said concept comprises a triplet of a set of child-concepts, a set of features, and a set of relationships.

17. The apparatus of claim 16 wherein said concepts comprise a hierarchical fuzzy graph data tree-structure comprising nodes, aggregation edges, and association edges and wherein:
said nodes correspond to said concepts and said features;
said aggregation edges correspond to parent-child relationships; and
said association edges correspond to said constraints.

18. The apparatus of claim 17 wherein said edges are weighted.

19. The apparatus of claim 13 further comprising a matching algorithm comprising GetNextMatch( ), AssignNextMatch( ), and ShiftNextMatch( ) procedures, wherein:
said GetNextMatch( ) procedure comprises the steps:
testqueue: if queue.Empty( );
return NULL;
head −−> queue.Pop( );
if head.Complete( );
return head;
head2 −−> head.Copy( );
head2.AssignNextMatch( );
if 2.Valid( );
queue.Pusg(head2);
head.ShiftNextMatch( );
queue.Push(head);
Goto testqueue;
said AssignNextMatch( ) procedure comprises the steps:
child −−> GetNextUnassigned( );
child.match_ptr++;
if (child.match_ptr} == NULL), then;
child.match_ptr −−> child.GetNextMatch( );
Make child an assigned node;
said ShiftNextMatch( ) procedure comprises the steps:
Child −−> GetNextUnassigned( );
child.match_ptr++;
if (child.match_ptr == NULL), then;
child.match_ptr −−> child.GetNextMatch( );
wherein variables head, head2, and child,
all correspond to concept nodes;
variable queue denotes a priority queue of
the corresponding concept node; and
match_ptr is a pointer to the next possible match
for a given concept node; Pop( ) is a
method to get the next node off the priority queue;
Push( ) is a method to put a node on
the priority queue; Empty( ) is a method to
check if the priority queue is empty; Copy( ) is
a method to copy a node; Complete( ) is a method to check
if the children assignment is
complete; Valid( ) is a method to check if the children
assignment meets the constraints;
and GetNextUnassigned( ) is a method to select
a variable that is unassigned.
